(19) United States
(12) Patent Application Publication
(10) Pub. No.: US 2026/0225499 A1
(43) Pub. Date: Aug. 6, 2026

(54) ASSEMBLY FOR A VEHICLE SEAT, PAIR OF SEAT RAILS FOR A VEHICLE SEAT, METHOD FOR MANUFACTURING AN ASSEMBLY FOR A VEHICLE SEAT, AND VEHICLE SEAT

(71) Applicant: Adient US LLC, Plymouth, MI (US)

(72) Inventor: Erik SPRENGER, Wermelskirchen (DE)

(21) Appl. No.: 19/466,821

(22) Filed: Feb. 2, 2026

(30) Foreign Application Priority Data
Feb. 3, 2025 (DE) 10 2025 103 843.0

(51) Int. Cl. B60N 2/015; B60N 2/06

(52) U.S. Cl. CPC B60N 2/015; B60N 2/06

(57) ABSTRACT

An assembly for a vehicle seat, in particular a floor rail of a pair of seat rails is provided. The assembly may have at least one spacer for abutment on a surface of a vehicle body, in particular for abutment on a vehicle floor. The at least one spacer may have at least one disc. A pair of seat rails for a vehicle seat are provided as well as a method for manufacturing the assembly for the vehicle seat and to the vehicle seat.

The invention relates to an assembly for a vehicle seat, in particular a floor rail of a pair of seat rails, the assembly comprising at least one spacer for abutment on a surface of a vehicle body, in particular for abutment on a vehicle floor. The invention also relates to a pair of seat rails for a vehicle seat, to a method for manufacturing an assembly for a vehicle seat and to a vehicle seat.

### Prior art

WO 2018/055055 A1 discloses a pair of seat rails for a vehicle seat, having a lower rail and an upper rail which is guided displaceably relative to the lower rail in the longitudinal direction, which lower and upper rails engage behind one another with their profiles, wherein the lower rail has a substantially C-shaped profile and the upper rail has a substantially U-shaped profile, wherein rolling elements are arranged between the lower rail and the upper rail. The lower rail has a substantially planar base which, as viewed in the transverse direction, is adjoined on both sides by upwardly bent, outer profile portions.

DE 102012018007 A1 discloses a spacer and fastening holder of a seat. Such a spacer and fastening holder makes it possible to realize a spacing of the seat, for example a lower rail of a longitudinal adjuster of the seat, from the vehicle floor. The spacer and fastening holder is formed by an elongate metal part, comprising a first end and a second end, wherein the first end is bent to form a U shape and the second end extends along a vertical direction and is provided and suitable to be received in a centring hole in a vehicle chassis.

In current seat rail systems, spacers are almost always used between a floor rail profile and a vehicle floor. These are required to bridge an installation space of the carpet in the vehicle. For heights from 1.5 to approx. 3.5 mm, spacers punched from sheet metal are frequently used. These are particularly inexpensive to produce, but have a limited thickness/height due to the production method. Cold extrusion parts are frequently used for larger heights of approx. 4 to 10 mm. Due to the comparatively complicated production method, these are significantly more expensive, also considered specifically per mm of height.

### Problem

The problem underlying the invention is to improve an assembly for a vehicle seat, for example a pair of seat rails of the type mentioned at the outset, in particular to make available a cost-effective solution for spacers with relatively large heights, and to provide a corresponding pair of seat rails, a corresponding vehicle seat and a corresponding method for manufacturing the assembly.

### Solution

This first-mentioned problem is solved according to the invention by an assembly for a vehicle seat, in particular a floor rail of a pair of seat rails for a vehicle seat, having the features of Claim 1. The second-mentioned problem is solved according to the invention by a pair of seat rails having the features of Claim 9. The third-mentioned problem is solved according to the invention by a method for manufacturing an assembly having the features of Claim 11. The fourth-mentioned problem is solved according to the invention by a vehicle seat having the features of Claim 14.

The assembly according to the invention for a vehicle seat, in particular a floor rail of a pair of seat rails, has at least one spacer for abutment on a surface of a vehicle body, in particular for abutment on a vehicle floor, wherein the at least one spacer has at least one disc which has at least one projection for welding to a component to be connected.

The at least one spacer can have at least two discs. At least two discs can be stacked on top of one another in a vertical direction to form a disc stack, in particular can be plugged on one another. The surface of the vehicle body can be a surface of a body shell. The surface of the vehicle body can be a surface of a coated, in particular painted, body shell. The surface of the vehicle body can be planar. The surface of the vehicle body can be curved.

At least two discs can be connected to one another. In particular, these at least two discs can be oriented and/or positioned with respect to one another by means of the at least one projection. Furthermore, these at least two discs can be pre-fixed to one another by means of the at least one projection. As a result, the at least two discs can be held secured to one another during connection, for example during welding, thereof.

At least two discs can be welded to one another. At least two discs can be projection-welded to one another. At least two discs can be laser-welded to one another. In each case two adjacent discs of a disc stack can be connected to one another, in particular welded to one another, in particular projection-welded and/or laser-welded to one another. The disc stack can have exactly two discs. The disc stack can have more than two discs, in particular have exactly three discs or exactly four discs.

A disc and a further component of the assembly, in particular a floor rail profile of a floor rail, can be connected to one another, in particular welded to one another, in particular projection-welded and/or laser-welded to one another. The uppermost disc of the disc stack can be connected, in particular welded, in particular projection-welded and/or laser-welded, to the further component of the assembly, in particular a floor rail profile of a floor rail. All the discs of the disc stack and a further component of the assembly can be welded to one another, in particular projection-welded to one another, by means of a single welding process. In particular in the case of a relatively high number of discs, all the discs of the disc stack and, where appropriate, a further component of the assembly can be laser-welded to one another.

A disc can bear on an embossment, in particular an island embossment, of a further component of the assembly, in particular can be welded to the embossment. The embossment can be an embossment in a floor rail profile of a floor rail. The embossment can be pronounced downwards. The embossment can be pronounced in the direction of the surface of the vehicle body, in particular in the direction of a vehicle floor. Owing to such an embossment, at least one disc can be saved, that is to say that the disc stack can have one disc fewer if it is connected to an embossment. The embossment can have the same height as a disc of the disc stack that bears on the embossment. The embossment can be a constituent part of the spacer. The spacer can consist exclusively of discs. The spacer can consist of two discs and an embossment in a further component of the assembly that adjoins a disc.

The assembly can have exactly one spacer. The assembly can have two or more spacers. The assembly can have a floor rail profile of a floor rail and exactly one spacer. The assembly can have a floor rail profile of a floor rail and exactly two spacers. A first spacer of two spacers can be arranged in a front half, in particular in a front end region of the floor rail profile. A second spacer of two spacers can be arranged in a rear half, in particular in a rear end region of the floor rail profile.

An assembly can have a floor rail profile of a floor rail, two spacers and at least one pin for positioning the floor rail in the vehicle. The pin can be connected, in particular welded, to the floor rail profile. The pin can be connected, in particular welded, to a disc of an adjacent disc stack.

At least two discs can be configured as identical parts, that is to say at least two discs are components which can be used multiple times in exactly one spacer in order to simplify production and reduce production costs. The configuration of the discs as identical parts enables more efficient manufacturing and storage by reducing the diversity of parts. All the discs of a disc stack can be configured as identical parts. A disc can have a material thickness of 1.0 mm to 4.0 mm, in particular of 1.5 mm to 3.5 mm. Each of the discs can have a material thickness of 1.0 mm to 4.0 mm, in particular of 1.5 mm to 3.5 mm. By stacking the discs to form a disc stack, it is possible to produce spacers which are many times higher than a single disc using thin discs which can be produced cost-effectively. Comparatively expensive cold extrusion parts with relatively large thicknesses can be dispensed with.

The discs can be made of metal, in particular steel. The discs can be made of metal sheet, in particular steel sheet. The discs can be punched out of metal sheet, in particular steel sheet.

The disc can have an opening for guiding through a fastening means, in particular a screw or a rivet. All the discs of a disc stack can each have an opening for guiding through a fastening means, in particular a screw or a rivet. The openings in the discs of a disc stack can be aligned with one another. The openings can be circular. The openings can each be a slot, which results in tolerance compensation.

The invention is also achieved by a pair of seat rails for a vehicle seat, comprising a floor rail and a seat part rail which is guided displaceably relative to the floor rail, wherein the floor rail comprises an assembly according to the invention, in particular an assembly having a floor rail profile and a disc or a disc stack. The pair of seat rails can have a floor rail with a floor rail profile and exactly two spacers.

The invention is also achieved by a method for manufacturing a previously described assembly according to the invention for a vehicle seat. The method comprises at least the following method steps:

a) inserting at least one component of the assembly, in particular a floor rail profile of a floor rail, into a welding device;

b) inserting at least two discs into the welding device, wherein the at least two discs have been arranged or are arranged to form a disc stack;

c) welding at least one disc of the disc stack to the at least one inserted component, and

d) welding the discs of the disc stack to one another, wherein the method steps c) and d) are in particular carried out simultaneously.

The welding according to the method steps c) and/or d) can be carried out by means of a welding method, in particular a resistance pressure welding method. The welding according to the method steps c) and/or d) can be carried out by means of a projection-welding method. The welding according to the method steps c) and/or d) can be carried out by means of an ultrasonic welding method. The welding according to the method steps c) and/or d) can be carried out by means of a laser-welding method, in particular for connecting a relatively large number of discs (number greater than two).

A further method for an assembly having at least one spacer, comprising only exactly one disc and an embossment in the component, provides the following method steps:

a) inserting at least one component of the assembly, in particular a floor rail profile of a floor rail, into a welding device;

b) inserting a disc into the welding device, wherein the disc has been arranged or is arranged on an embossment of the inserted component;

c) welding the disc to the embossment of the inserted component.

The invention is also achieved by a vehicle seat, comprising at least one previously described assembly according to the invention, in particular at least one pair of seat rails, wherein, when placing on the surface of the vehicle body, in particular on a vehicle floor, the vehicle seat can be brought into direct contact with the surface, in particular exclusively, via the at least one spacer. A region between two spacers below a pair of seat rails can be spaced apart from the vehicle body when the two spacers are placed on the surface of the vehicle body. This can be used to receive carpet and/or to fix it by clamping.

In summary, and in other words, the invention provides a cost-effective solution for spacers having relatively large heights.

The core of the invention is that a plurality of thin spacers are stacked on top of one another and welded, in particular at once. For example, the projection-welding method can be used for this purpose. Thus, for example, two spacers can be stacked on top of one another and can be projection-welded or laser-welded at the same time. Especially with relatively large heights of the stack, projection welding may no longer be possible. With lateral laser welding, for example, an unlimited number of discs can be welded on top of one another to form a spacer. The discs can be combined with an embossment in the bottom of the rail. This can represent a particularly cost-effective solution. Thus, for example, a 4.5-mm-high cold-extruded spacer, which is comparatively cost-intensive to produce, can be replaced by an embossment in the rail profile of 1.5 mm and two spacers of 1.5 mm. By using thicker punched spacers, for example with a wall thickness of 3.5 mm, even larger heights of the spacers can be achieved in the case of multiple stacking.

### DESCRIPTION OF THE FIGURES

In the following text, the invention is explained in more detail using advantageous exemplary embodiments illustrated in the figures. However, the invention is not limited to these exemplary embodiments. In the figures:

FIG. 1 shows a schematic side view of a vehicle seat according to the invention,

FIG. 2 shows a perspective view of a disc stack, consisting of two discs, of a spacer of an assembly according to the invention,

FIG. 3 shows, as a detail, a perspective view of an assembly, configured as a floor rail, with a spacer, the spacer comprising a disc stack consisting of two discs and an embossment in a floor rail profile of the floor rail,

FIG. 4A shows an alternative exemplary embodiment of a disc stack consisting of three discs,

FIG. 4B shows an alternative exemplary embodiment of a disc stack consisting of four discs,

FIG. 5 shows a schematic side view of an assembly according to the invention, configured as a floor rail, with two spacers, each having exactly one disc,

FIG. 6A shows a perspective view of the assembly according to the invention from FIG. 5,

FIG. 6B shows an enlarged illustration of the detail VI-B from FIG. 6A (a spacer consisting of exactly one disc and exactly one embossment in the floor rail),

FIG. 6C shows an enlarged illustration of the detail VI-C from FIG. 6A (a spacer consisting of exactly one disc),

FIG. 7 shows a schematic side view of an assembly according to the invention, configured as a floor rail, according to a further exemplary embodiment, comprising two spacers, each comprising a disc stack consisting of exactly two discs,

FIG. 8A shows a perspective view of the assembly according to the invention from FIG. 7,

FIG. 8B shows an enlarged illustration of the detail VIII-B from FIG. 8A (a spacer consisting of a disc stack, having exactly two discs, and exactly one embossment in the floor rail),

FIG. 8C shows an enlarged illustration of the detail VIII-C from FIG. 8A (a spacer consisting of a disc stack having exactly two discs),

FIG. 9 shows a schematic side view of an assembly according to the invention, configured as a floor rail, according to a further exemplary embodiment, comprising two spacers, each comprising a disc stack consisting of exactly three discs,

FIG. 10A shows a perspective view of the assembly according to the invention from FIG. 9,

FIG. 10B shows an enlarged illustration of the detail X-B from FIG. 10A (a spacer consisting of a disc stack, having exactly three discs, and exactly one embossment in the floor rail), and

FIG. 10C shows an enlarged illustration of the detail X-C from FIG. 10A (a spacer consisting of a disc stack having exactly three discs).

### DETAILED DESCRIPTION

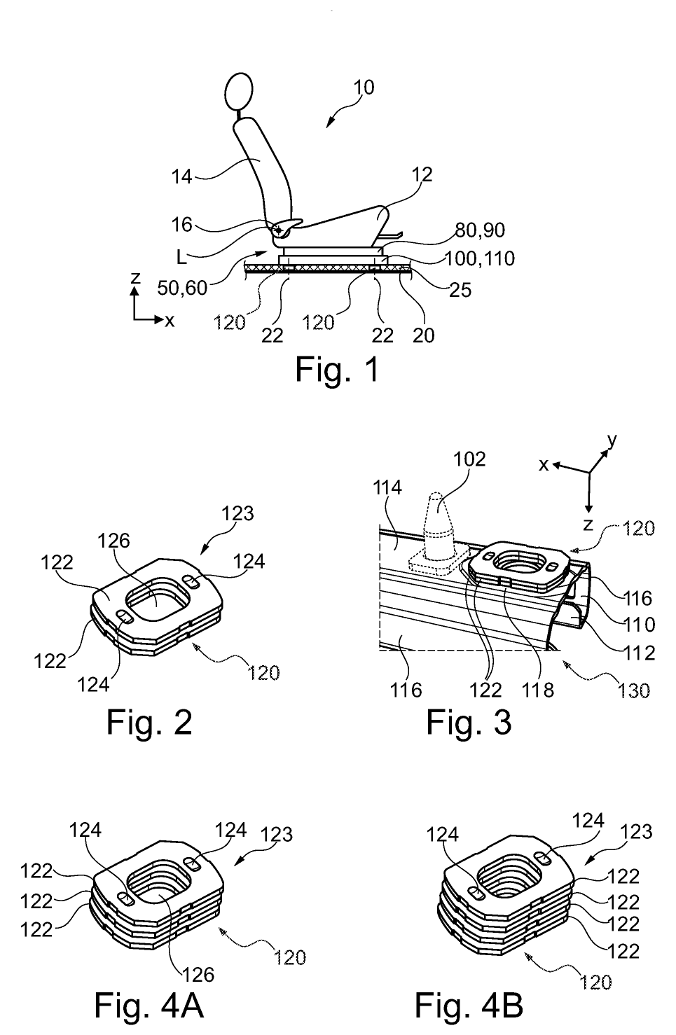

FIG. 1 is a highly schematic illustration showing a vehicle seat 10 according to the invention, which is mounted on a vehicle floor 20. The vehicle floor 20 is covered with a carpet 25.

The vehicle seat 10 is described below using three spatial directions extending perpendicularly with respect to one another. A longitudinal direction x extends, in a vehicle seat 10 installed in the vehicle, largely horizontally and preferably parallel to a vehicle longitudinal direction which corresponds to the usual direction of travel of the vehicle. A transverse direction y, extending perpendicularly with respect to the longitudinal direction x, is likewise oriented horizontally in the vehicle and extends parallel to a vehicle transverse direction. A vertical direction z extends perpendicularly with respect to the longitudinal direction x and perpendicularly with respect to the transverse direction y. In a vehicle seat 10 installed in the vehicle, the vertical direction z extends parallel to the vehicle vertical axis.

The position indications and direction indications used, such as left, right, front, rear, top, bottom, transversely, laterally and on both sides, refer to a direction of view of an occupant sitting in the usual sitting position on a seat surface of a seat substructure 12 (seat part) of the vehicle seat 10, wherein the vehicle seat 10 is installed in the vehicle in a use position suitable for carrying people, and is oriented in the usual manner in the direction of travel. However, the vehicle seat 10 can also be installed in a different orientation, for example transversely with respect to the direction of travel. Unless otherwise described below, the vehicle seat 10 is constructed mirror-symmetrically with respect to a plane running perpendicularly with respect to the transverse direction y.

A backrest 14 is connected to the seat substructure 12 on both sides by means of a respective fitting 16 so as to be adjustable in inclination about a backrest pivot axis L.

The seat substructure 12 has a seat longitudinal adjuster 50 for the longitudinal adjustment of the vehicle seat 10. In the present case, the seat longitudinal adjuster 50 comprises a pair of seat rails 60 on both sides. Each of the two pairs of seat rails 60 has a floor rail 100, in particular a lower rail, which is connectable to a vehicle floor 20, in particular by means of screws 22, and a seat part rail 80, in particular an upper rail, which is connected to a longitudinally adjustable part of the seat substructure 12. The seat part rail 80 is guided in a longitudinally displaceable manner on the floor rail 100.

The two pairs of seat rails 60 can be electromotively displaceable with respect to one another, for example by means of a spindle drive known per se. Alternatively, the two pairs of seat rails 60 can be manually displaceable with respect to one another after a rail longitudinal lock known per se, for example a locking plate transferable vertically between a locking position and an unlocking position, is unlocked.

The two pairs of seat rails 60 are largely mirror-symmetrical with respect to one another, so that only one pair of seat rails 60 is described below. The description applies to both pairs of seat rails 60, unless otherwise described below.

As shown in FIG. 1, to ensure a fixed connection between the floor rail 100 and the vehicle floor 20, the floor rail 100 has two spacers 120. A first of the two spacers 120 is arranged in a front end region of the floor rail 100 below the floor rail profile 110 and preferably fastened thereto. A second of the two spacers 120 is arranged in a rear end region of the floor rail 100 below the floor rail profile 110 and preferably fastened thereto. The two spacers 120 lie directly on the vehicle floor 20, in particular without interposition of the carpet 25. The carpet 25 has corresponding cutouts for the spacers 120. In addition to the spacers 120, the carpet 25 can be clamped between the floor rail profile 110 and the vehicle floor 20.

The floor rail 100 has the floor rail profile 110, in particular consisting of a formed steel sheet. The seat part rail 80 has a seat part rail profile 90, in particular consisting of a formed steel sheet.

When mounted in the vehicle in an installed state, the floor rail profile 110 and the seat part rail profile 90 each extend largely parallel to the longitudinal direction x, wherein a small acute angle to the longitudinal direction x may exist. The floor rail profile 110 and the seat part rail profile 90 engage behind one another with their profiles. The floor rail profile 110 has an upwardly open, substantially C-shaped profile cross section with profile end portions 112 bent downwards at the ends. The floor rail profile 110 has a substantially planar profile base 114 which is adjoined on both sides by upwardly bent outer profile side portions 116. The upwardly bent profile side portions 116 transition, at their ends opposite to the profile base 114, into the downwardly bent profile end portions 112. In the present case, the profile base 114 forms a web of the C-shaped profile cross section. In the present case, the two profile side portions 116 each form a flange of the C-shaped profile cross section.

The seat part rail profile 90 of the seat part rail 80 has a downwardly open, substantially U-shaped profile cross section with upwardly bent end portions. The seat part rail profile 90 has a substantially planar web which, as viewed parallel to the transverse direction y, is adjoined on both sides by downwardly bent legs. The downwardly bent legs transition, at their ends opposite to the web, into the upwardly bent end portions.

The upwardly bent end portions of the seat part rail profile 90 are guided in the outer profile end portions 112 of the floor rail profile 110. In lower rolling element raceways and upper rolling element raceways, rolling elements are arranged between the floor rail profile 110 and the seat part rail profile 90 and facilitate a relative displacement between the seat part rail profile 90 and the floor rail profile 110.

FIG. 2 shows a spacer 120 which consists of exactly two discs 122. The two discs 122 are identical parts. In all the exemplary embodiments shown in FIGS. 2 to 10C, the same discs 122 are used. The following description of a disc 122 (in the singular) is thus applicable for all the discs 122 of the exemplary embodiments shown in FIGS. 2 to 10C. However, the invention is not limited to embodiments in which the discs are configured as identical parts.

The disc 122 is planar. The disc 122 can comprise a number of projections 124, for example one, two or more projections 124. The projection(s) 124 serves/serve for projection welding of two adjacent discs 122 to one another and/or for projection welding of a disc 122 to a component of an assembly 130, in particular to a floor rail profile 110 of a floor rail 100. The projection(s) 124 concentrates/concentrate heat and pressure at the connection points to allow an efficient and precise welded connection.

In the case of a plurality of discs 122, these can be formed identically. In particular, they can have an identical number of projections 124. In the case of a plurality of projections 124, they can be arranged symmetrically distributed on the respective disc 122. For example, two projections 124 can be arranged opposite one another on the disc 122.

The respective projection 124 can be pin-shaped, mushroom-shaped, web-shaped or the like. The respective projection 124 can in particular protrude perpendicularly from the planar disc 122. The respective projection 124 can additionally be designed as a positioning element and/or orienting element so that the parts to be connected to one another, such as disc 122 and component and/or adjacent discs 122, can be positioned and/or oriented with respect to one another before the connection.

In addition, the respective projection 124 can be designed to pre-fix the parts to be connected to one another, such as disc 122 and component and/or adjacent discs 122, during the connection, in particular the projection welding. For example, the parts to be connected to one another can be pre-positioned and/or pre-fixed by means of the projection 124, in particular be releasably positioned and held in a form-fitting and/or force-fitting manner. For this purpose, the respective projection 124 can be designed to be hollow, for example, so that in the state in which the parts, the disc(s) 122 and/or the component, are arranged on one another, a projection 124 of one part engages in a corresponding cavity of the hollow projection 124 of an adjacent part. In other words: The parts, in particular the disc 122 and the component and/or adjacent discs 122, can be plugged onto one another via the hollow projections 124. Alternatively, the projections 124 can be closed and the respective disc 122 and/or the respective component can have receiving openings, which correspond to the respective projection 124 of the adjacent part, for the respective projection 124.

The disc 122 has a substantially rectangular basic shape with four bevelled corners. The shorter sides of the disc 122 can be curved convexly. The sides of the disc 122 can each have central indentations. The disc 122 has an opening 126 as a through hole for a screw 22. The floor rail 100 can be screwed to the vehicle floor 20 in the region of the associated spacer 120 by means of the screw 22, so that only small bending moments, if any, act on the spacer 120. The opening 126 is configured as a slot, for example to compensate for positional tolerances of threads in the vehicle floor 20 which correspond to the screws 22.

For example, the disc 122 is punched out of a steel sheet. For example, a disc height of the disc 122 can be 1.5 mm. The disc 122 is then punched out, for example, from a steel sheet with a material thickness of 1.5 mm.

The spacer 120 shown in FIG. 2 is used, for example, in the exemplary embodiment shown in FIG. 8C.

FIG. 3 shows, as a detail, an assembly 130, configured as a floor rail 100, with a spacer 120 consisting of a disc stack 123, having exactly two discs 122, and exactly one embossment 118 in a profile base 114 of a floor rail profile 110 of the floor rail 100. The embossment 118 can have the same height as each of the discs 122. In the spacer 120 shown in FIG. 3, the embossment 118 is a constituent part of the spacer 120 that is integrated into the floor rail profile 110. As a result of the embossment 118, the spacer 120 has a relatively large height. Thus, for example, an equally high disc 122 can be dispensed with. The spacer 120 shown in FIG. 3 is used, for example, in the exemplary embodiment shown in FIG. 8B.

FIG. 3 also shows a pin 102 for positioning the floor rail 100 in the vehicle. The pin 102 is welded to the floor rail profile 110. When mounting the vehicle seat 10 in the vehicle, the pin 102 is inserted into a corresponding centring hole in the vehicle floor 20, so that pre-positioning is carried out before the vehicle seat 10 is screwed to the vehicle floor 20 by means of the screws 22. The pin 102 is optional and not essential to the invention in every case. Therefore, the pin 102 in FIG. 3 is shown in dashed lines.

FIG. 4A shows a spacer 120 which consists of a disc stack 123 with exactly three discs 122. The spacer 120 shown in FIG. 4A is used, for example, in the exemplary embodiment shown in FIG. 10C. FIG. 4B shows a spacer 120 which consists of a disc stack 123 with exactly four discs 122. The spacers 120 shown in FIGS. 4A and 4B can each be expanded by combination with an embossment in an adjacent component to form a spacer which is higher by the height of the embossment.

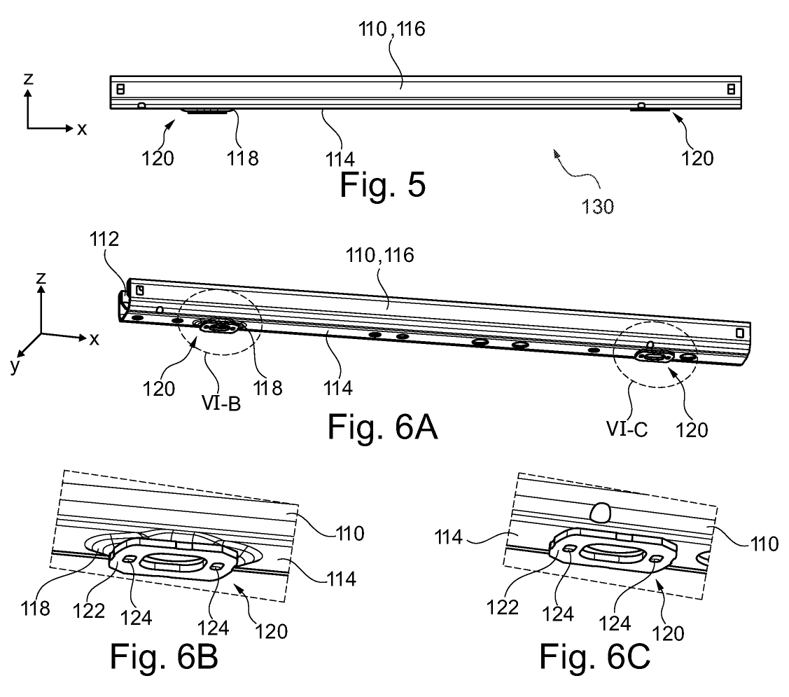

FIGS. 5 and 6A show an exemplary embodiment of an assembly 130 comprising a floor rail profile 110 and two spacers 120. One of the two spacers 120 is illustrated in the detail VI-B (FIG. 6B) and consists of exactly one disc 122 and an embossment 118 in a profile base 114 of the floor rail profile 110. The embossment 118 protrudes from a base surface of the profile base 114 in the direction of the disc 122. On a side of the embossment 118 facing away from the disc 122, the embossment 118 can also serve to receive a screw head of a screw 22. The second of the two spacers 120 is illustrated in the detail VI-C (FIG. 6C) and consists of exactly one disc 122.

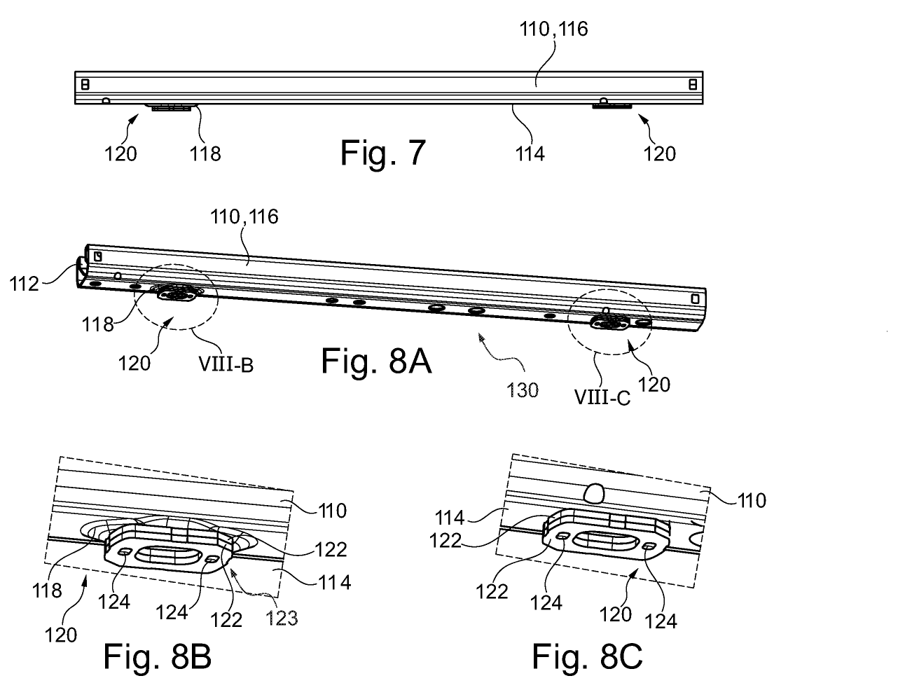

FIGS. 7 and 8A show an exemplary embodiment of an assembly 130 comprising a floor rail profile 110 and two spacers 120. One of the two spacers 120 is illustrated in the detail VIII-B (FIG. 8B) and consists of a disc stack 123, having exactly two discs 122, and exactly one embossment 118 in a profile base 114 of the floor rail profile 110. The embossment 118 protrudes from a base surface of the profile base 114 in the direction of the disc stack 123. On a side of the embossment 118 facing away from the disc stack 123, the embossment 118 can also serve to receive a screw head of a screw 22. The second of the two spacers 120 is illustrated in the detail VIII-C (FIG. 8C) and consists of a disc stack 123 having exactly two discs 122.

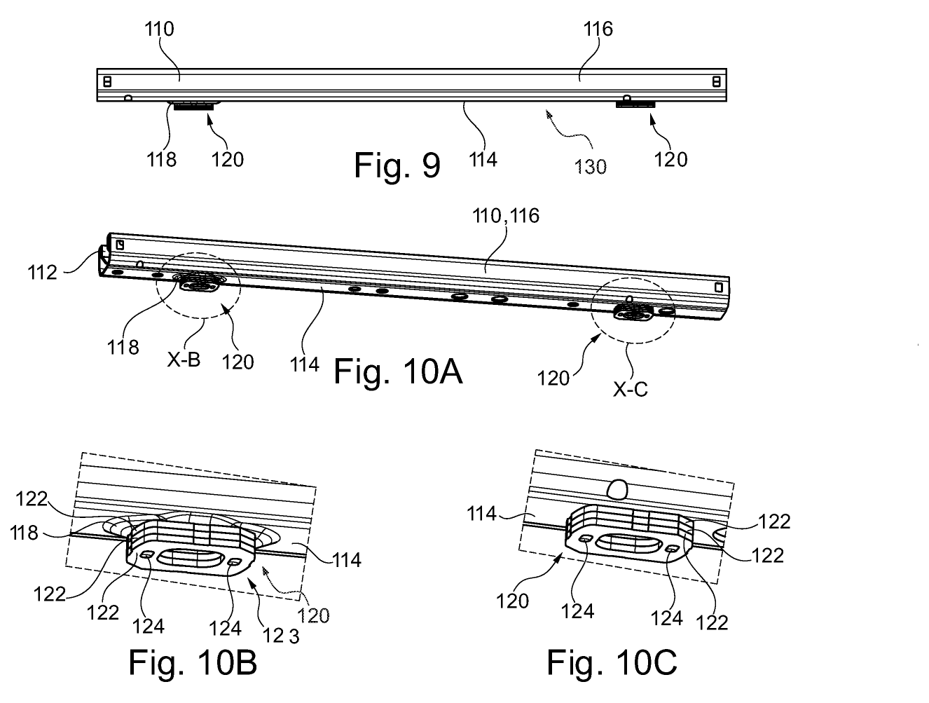

FIGS. 9 and 10A show an exemplary embodiment of an assembly 130 comprising a floor rail profile 110 and two spacers 120. One of the two spacers 120 is illustrated in the detail X-B (FIG. 10B) and consists of a disc stack 123, having exactly three discs 122, and exactly one embossment 118 in a profile base 114 of the floor rail profile 110. The embossment 118 protrudes from a base surface of the profile base 114 in the direction of the disc stack 123. On a side of the embossment 118 facing away from the disc stack 123, the embossment 118 can also serve to receive a screw head of a screw 22. The second of the two spacers 120 is illustrated in the detail X-C (FIG. 10C) and consists of a disc stack 123 having exactly three discs 122.

By virtue of the fact that the disc stacks 123 in all exemplary embodiments consist of identical discs 122, further assemblies according to the invention can be created in a simple manner. The number of discs 122 in a disc stack 123 and the use of an embossment 118 are simple parameters to adjust the height of the spacer 120. The features disclosed in the above description, the claims and the figures may therefore be significant, both individually and in combination, for the implementation of the invention in its various embodiments, insofar as they remain within the scope of protection of the claims.

A method (not shown in the figures) for manufacturing an assembly 130 according to the invention, in particular a floor rail 100 of a pair of seat rails 60, comprises at least the following method steps:

a) inserting at least one component of the assembly 130, in particular a floor rail profile 110 of a floor rail 100, into a welding device;

b) inserting at least two discs 122 into the welding device, wherein the at least two discs 122 have been arranged or are arranged to form a disc stack 123;

c) welding at least one disc 122 of the disc stack 123 to the at least one inserted component, and

d) welding the discs 122 of the disc stack 123 to one another, wherein the method steps c) and d) are in particular carried out simultaneously.

The welding according to the method steps c) and/or d) can be carried out by means of a resistance pressure welding method, in particular by means of a projection-welding method. The welding according to the method steps c) and/or d) can alternatively be carried out by means of a laser-welding method.

### List of reference signs

10 Vehicle seat

12 Seat substructure

14 Backrest

16 Fitting

20 Vehicle floor

22 Screw

25 Carpet

50 Longitudinal adjuster

60 Pair of seat rails

80 Seat part rail

90 Seat part rail profile

100 Floor rail

102 Pin

110 Floor rail profile

112 Profile end portion

114 Profile base

116 Profile side portion

118 Embossment, island embossment

120 Spacer

122 Disc

123 Disc stack

124 Projection

126 Opening

130 Assembly

L Backrest pivot axis

x Longitudinal direction

y Transverse direction

z Vertical direction

What is claimed is:

1. An assembly for a vehicle seat, comprising at least one spacer for abutment on a surface of a vehicle body,
characterized in that the at least one spacer has at least one disc which has at least one projection for welding to a component to be connected.

2. The assembly according to claim 1, characterized in that the part to be connected is a further adjacent disc and/or an adjacent component of the assembly.

3. The assembly according to claim 1, characterized in that the at least one spacer has at least two discs which are arranged to form a disc stack and welded to one another.

4. The assembly according to claim 3, characterized in that a disc of the at least two discs and the further component of the assembly are welded to one another.

5. The assembly according to claim 1, characterized in that the at least one disc butts on an embossment of the further component of the assembly.

6. The assembly according to claim 5, characterized in that the at least one disc is welded to the embossment.

7. The assembly according to claim 3, characterized in that at least two discs of the disc stack are configured as identical parts.

8. The assembly according to claim 3, characterized in that the at least two discs each have an opening for guiding through a fastening means, wherein the openings are aligned with one another.

9. A pair of seat rails for the vehicle seat, comprising a floor rail and a seat part rail which is guided displaceably relative to the floor rail, characterized in that the floor rail has the assembly according to one of claim 1.

10. A pair of seat rails, characterized in that the assembly has a floor rail profile and a disc stack.

11. A method for manufacturing an assembly for the vehicle seat according to claim 1, characterized by at least the following method steps:
a) inserting at least one component of the assembly into a welding device;
b) inserting at least two discs into the welding device, wherein the at least two discs have been arranged or are arranged to form a disc stack;
c) welding at least one disc of the disc stack to the at least one inserted component, and
d) welding the discs of the disc stack to one another.

12. The method according to claim 11, wherein the method steps c) and d) are carried out simultaneously.

13. The method according to claim 12, characterized in that the welding according to the method steps c) and/or d) is carried out by means of a welding method.

14. The vehicle seat, comprising at least one assembly according to claim 1, wherein, when placing on the surface of the vehicle body, the vehicle seat is brought into direct contact with the surface of the vehicle body via the at least one spacer.

15. The vehicle seat according to claim 14, wherein the vehicle seat is brought into direct contact with the surface of the vehicle body exclusively via the at least one spacer.
